(19) United States
(12) Patent Application Publication
(10) Pub. No.: US 2007/0257903 A1
(43) Pub. Date: Nov. 8, 2007

(54) GEOGRAPHIC INFORMATION SYSTEM (GIS) FOR DISPLAYING 3D GEOSPATIAL IMAGES WITH REFERENCE MARKERS AND RELATED METHODS

(75) Inventors: Guillermo E. Gutierrez, Melbourne, FL (US); Timothy B. Faulkner, Palm Bay, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Harris Corporation, Melbourne, FL (US)

(21) Appl. No.: 11/381,628

(22) Filed: May 4, 2006

(51) Int. Cl. G06T 15/00

(52) U.S. Cl. 345/419

(57) ABSTRACT

A geographic information system (GIS) may include a display, a GIS database, and a processor the processor may cooperate with the display and the GIS database to display a three-dimensional (3D) geospatial image including a plurality of spaced-apart reference markers therein. The reference markers may have different visual characteristics indicative of different relative positions within the 3D geospatial image. The processor may also associate with each reference marker selectively displayable position data. The reference markers may have different sizes and/or colors, for example.

### FIELD OF THE INVENTION

The present invention relates to the field of image processing systems, and, more particularly, to geographic information systems (GIS) and related methods.

### BACKGROUND OF THE INVENTION

In certain applications it is desirable to provide digital representations of three-dimensional (3D) objects or images. By way of example, such applications may include mapping programs (e.g., Google Earth) architectural design applications (e.g., Pro/E, CATIA), digital design and modeling tools (e.g. Maya, 3DStudio Max), and three-dimensional visualization analysis tools.

One challenge of displaying and interacting with digital 3D images on a computer is that this is traditionally accomplished using two-dimensional (2D) interaction mechanisms. More particularly, in 3D application domains, a 3D object is typically created/edited using only 2D input/output devices such as a monitor or display, mouse, keyboard, and/or joystick. This is usually done in one of two ways. The first way is to create or place a 3D object in the scene, which can be a cumbersome multi-step process. The object is first created or placed in a two-dimensional plane and then manipulated in the third dimension. While there are multiple points of view often being displayed simultaneously, the process may still be relatively unintuitive to the user.

In accordance with another approach objects can be natively placed directly in 3D space, but usually only relative to a pre-existing 3D object which already has a spatial context in the current coordinate system. One example of an application which allows objects to be natively placed in a 3D space is the InReality™ sitemodel viewer from the present Assignee, Harris Corp. InReality™ also provides a sophisticated interaction within a 3D virtual scene allowing users to easily move through a geospatially accurate virtual environment with the capability of immersion at any location within a scene.

Various approaches have been developed for arranging or placing graphical objects on a display. One example of a 2D arrangement for object placement on windows is disclosed in U.S. Pat. No. 5,883,625 to Crawford et al. This patent is directed to a system and method for automatically arranging objects inside a container of a graphical user interface (GUI). Selectable grid styles are provided for arranging cells into different configurations inside the container. The cells may be placed in different grid styles, such as rectangular, rhombus-shaped, or circular. Furthermore, identifiers are used for placing objects such as icons or buttons in each cell and ordering the objects for other user applications.

While such approaches may be helpful for interacting with 2D images, these approaches may not be of use for working with 3D images. While certain haptic (i.e., technology that interfaces the user via the sense of touch) and inherently 3D input devices do exist which attempt to facilitate interaction with 3D data, such devices are typically expensive, require specialized hardware/software, have a substantial learning curve, and/or are not readily available.

### SUMMARY OF THE INVENTION

In view of the foregoing background, it is therefore an object of the present invention to provide a system and related methods for facilitating interaction with 3D data, such as 3D geospatial images, for example.

This and other objects, features, and advantages are provided by a geographic information system (GIS) which may include a display, a GIS database, and a processor. More particularly, the processor may cooperate with the display and the GIS database to display a three-dimensional (3D) geospatial image including a plurality of spaced-apart reference markers therein. The reference markers may have different visual characteristics indicative of different relative positions within the 3D geospatial image. The processor may also associate with each reference marker selectively displayable position data.

By way of example, the different visual characteristics may include different sizes and/or different colors. An input device may also be connected to the processor, and the processor may selectively display position data for a given reference marker based upon the input device. For example, in the case of a mouse, the processor may display the position data when a mouse cursor is moved to point at the given reference maker. By way of example, the selectively displayable position data may include selectively displayable latitude, longitude, and height coordinates, for example.

The input device may also cooperate with the processor to draw a line between a pair of reference markers, and the processor may cooperate with the display to display a distance between the pair of reference markers based upon the line. In addition, the input device may further cooperate with the processor to select a given reference marker from among the plurality of reference markers. Also, the 3D geospatial image may include a ground surface below the given reference marker. As such, the processor may cooperate with the display to draw a vertical reference line between the ground surface and the given reference marker upon selection thereof. The reference markers may be semi-transparent geometric objects, such as semi-transparent spheres, for example.

The processor may also cooperate with the display to selectively change the spacing between the reference markers based upon the input device. In some embodiment, the spacing between at least some of the reference markers may be non-uniform and/or non-linear. The input device may be used for selecting reference markers. As such, the 3D geospatial image may include at least one polygon, and the processor may determine an orientation of the at least one polygon based upon an order of selection of reference markers associated therewith.

Furthermore, the processor may selectively display the plurality of reference markers with the 3D geospatial image based upon the input device. For example, if the input device is a keyboard, the processor may display the reference markers when a given key(s) is depressed, and remove the reference markers from the display when the given key(s) is released.

A three-dimensional (3D) geospatial image display method aspect may include displaying the 3D geospatial image on a display with a plurality of spaced-apart reference markers therein. The reference markers may have different visual characteristics indicative of different relative positions within the 3D geospatial image. The method may further include associating with each reference marker selectively displayable position data.

### BRIEF DESCRIPTION OF THE DRAWINGS

FIG. 1 is a schematic block diagram of an exemplary geographic information system (GIS) in accordance with the invention.

FIG. 2 is a sample display of a 3D image with reference markers in accordance with the invention with selectively displayed position data.

FIG. 3 is a sample display of the 3D image of FIG. 2 displaying a distance between a pair of reference markers and with a different spacing between reference markers.

FIG. 4 is a sample display of the 3D image of FIG. 2 displaying a vertical reference line from the ground surface in the image to a reference marker, and the associated height.

FIG. 5 is a sample display of the 3D image of FIG. 2 with an alternative embodiment of the reference markers having different colors to indicate different relative positions within the image.

FIG. 6 is a sample display of another 3D image including semi-transparent spherical reference markers in accordance with the invention.

FIG. 7 is a sample display illustrating a 3D geospatial image display method in accordance with the invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation are used to indicate similar elements in alternate embodiments.

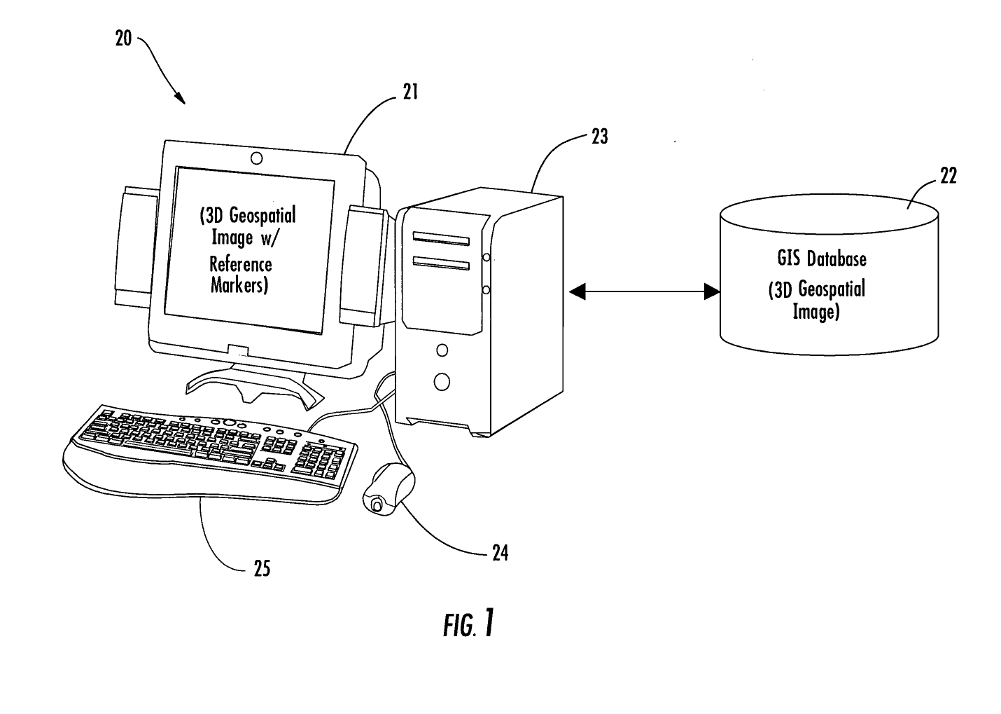

Referring initially to FIG. 1, a geographic information system (GIS) 20 illustratively includes a display 21, a GIS (or other 3D image) database 22, and a processor 23 (e.g., a computer CPU). Moreover, input devices such as a mouse 24 and a keyboard 25 are connected to the processor 23 for allowing a user to interact with and manipulate data (e.g., image data) displayed on the display 21. Other input devices such as a joystick (not shown) may also be used, as will be appreciated by those skilled in the art.

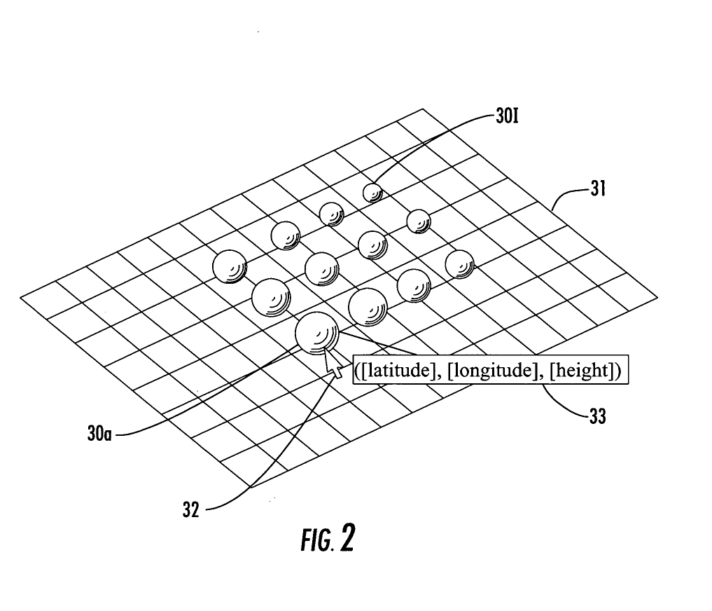

Generally speaking, the processor 23 cooperates with the display 21 and the GIS database 22 to display a three-dimensional (3D) geospatial image stored in the GIS database, along with a plurality of spaced-apart reference markers 30a-30l therein. In FIGS. 2-5, the 3D image is simply a ground (e.g., terrain) surface or grid so that the reference markers 30a-30l are more easily identifiable. Moreover, the reference markers 30a-30l are spheres in these embodiments, but other geometric shapes or markers may also be used.

The reference markers 30a-30l advantageously have different visual characteristics indicative of different relative positions within the 3D geospatial image to help users more readily distinguish the relative positions of object vertices, boundaries, elevations, etc., within an image. By way of example, in FIGS. 2-4 the different visual characteristics of the reference markers 30a-30l are their different relative sizes. For example, the reference marker 30a which is in the foreground is larger than the reference marker 30l in the background, which indicates to the user that the reference marker 30a is “closer” with respect to the particular angle at which the user is viewing the 3D image (i.e., closer from the user's vantage point).

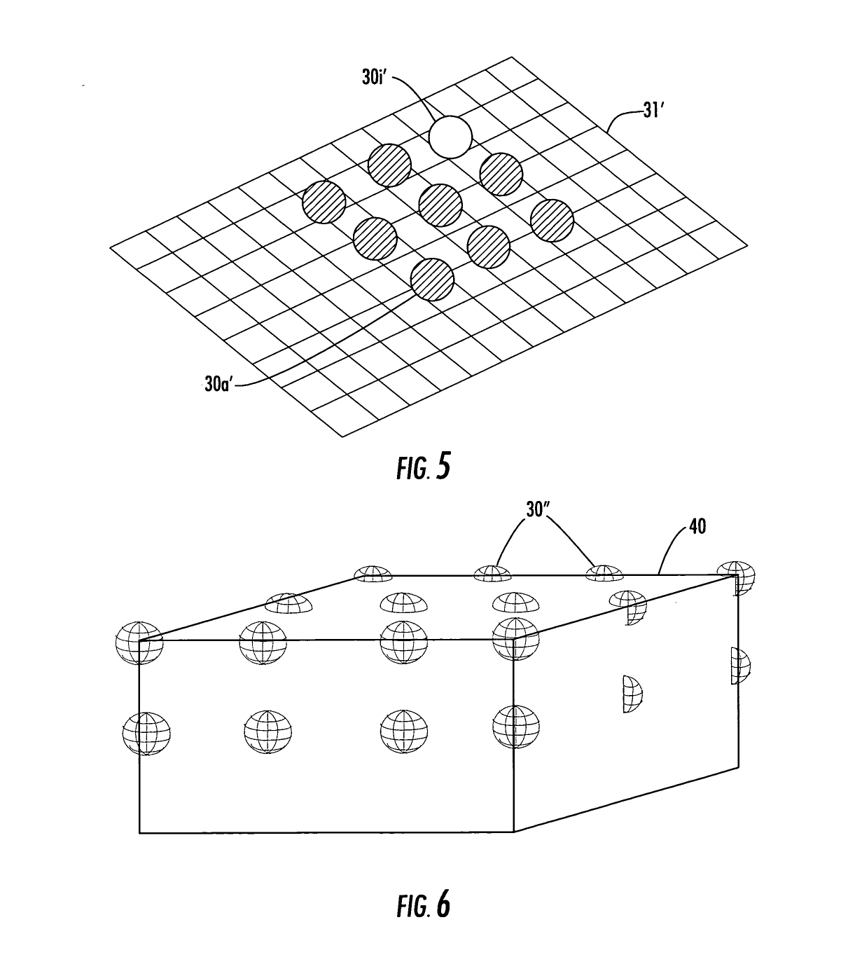

Other visual characteristics besides size may be used to help visually indicate to a user the relative position of reference markers within an image. For example, in the alternative embodiment illustrated in FIG. 5, reference markers 30a′-30i′ have different colors (illustrated by different grayscale shade) to indicate their relative positions within the image. In this example, the darker colored reference markers appear in the foreground, and as the markers get farther away from the user's vantage point their color becomes lighter, although other arrangements may also be used. In some embodiments, both color and size may be used to indicate relative positions within an image, as will be appreciated by those skilled in the art. Moreover, individual reference markers may be colorized based upon elevation from the ground surface 31 (in a geo-referenced context), or more generally, based upon a distance from a pre-defined point or surface.

The processor 23 may also advantageously associate with each reference marker selectively displayable position data. Thus, in the case of a 3D geospatial image of a particular city or other location in which the points in the image are referenced to actual latitude, longitude, and/or height/elevation coordinates for the particular city, etc., the processor 24 will associate respective position data with each reference marker 30a-30l based upon its position within the image, as will be appreciated by those skilled in the art. Of course, for applications other than GIS (e.g., architectural design applications, digital design modeling tools, etc.), the position data may be referenced to a particular object in a scene based upon a scale, etc., as will be appreciated by those skilled in the art.

In particular, the processor 23 may cause the display 21 to display the position data associated with a given reference marker 30 when the user selects the given reference marker. In the example illustrated in FIG. 2, the user has selected the reference marker 30a by moving a mouse cursor 32 to point thereto, which causes the processor to generate a pop-up window 33 displaying the latitude, longitude, and height/elevation coordinates associated with this particular reference marker. In other cases, selection could be performed by pressing a given mouse button or keyboard key, for example. Additionally, the given reference marker's current coordinates may be displayed and updated in real time as the density of the reference markers is changed, if desired, as will be discussed further below.

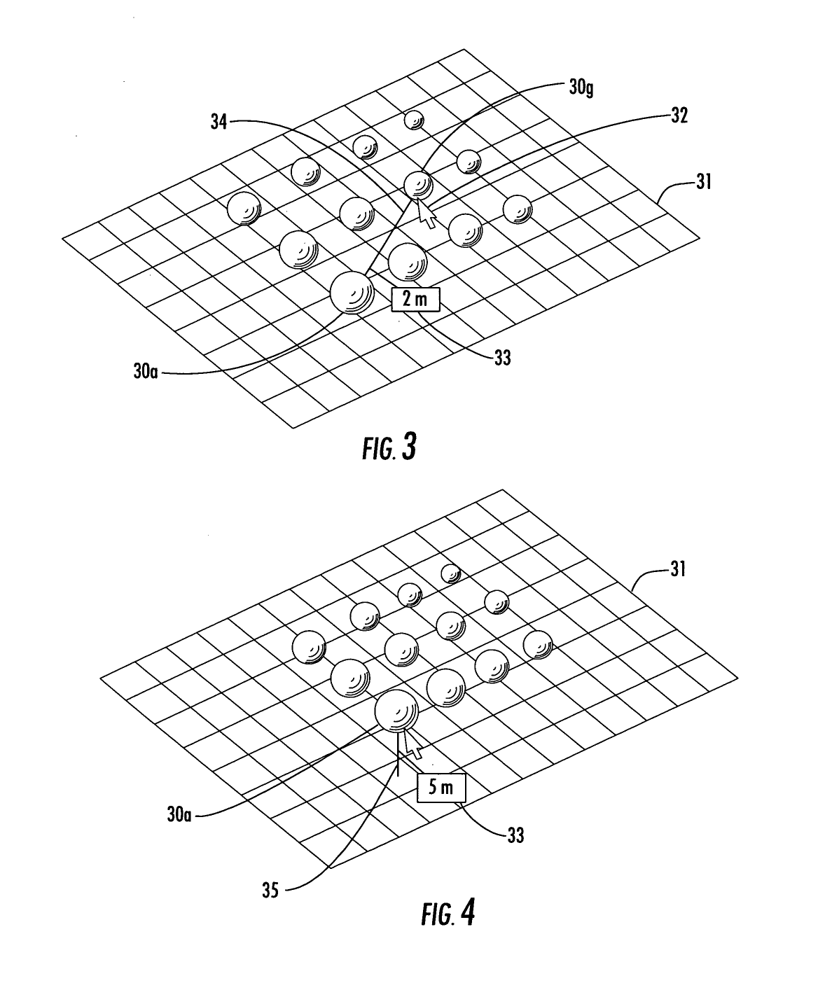

The mouse 24 may also be used to draw a line 34 between a pair of reference markers 30a and 30g, as seen in FIG. 3. This may done by simply selecting a first reference marker (here the reference marker 30a), such as by clicking a mouse button when the mouse pointer 32 is pointing thereto, and then dragging the line 34 to the second reference marker 30g and releasing the mouse button. Of course, other approaches for selecting and/or drawing lines between reference markers may also be used, as will be appreciated by those skilled in the art. The processor 23 may also display the pop-up window 33, which in this example displays a distance between the two reference markers (i.e., 2 m). This feature may be particularly beneficial for city planners, etc., who need to determine a distance from one point in a 3D scene (such as the top of one building) to another point (e.g., the top of another building), for example.

Yet another similar feature is that the mouse 24 (or keyboard 25 or other appropriate input devices) may be used to select a given reference marker 30a so that the processor 23 may cause a vertical reference line 35 to be drawn between the ground surface and the given reference marker upon selection thereof, as seen in FIG. 4. That is, the vertical reference line 35 provides a helpful reference for the user to determine where the ground surface 31 directly beneath the given reference marker 30a is located. In addition, the pop-up window may also be generated on the display 21 by the processor 23 with an indication of the distance between the ground surface 31 and the given reference marker 30a (here, 5 m).

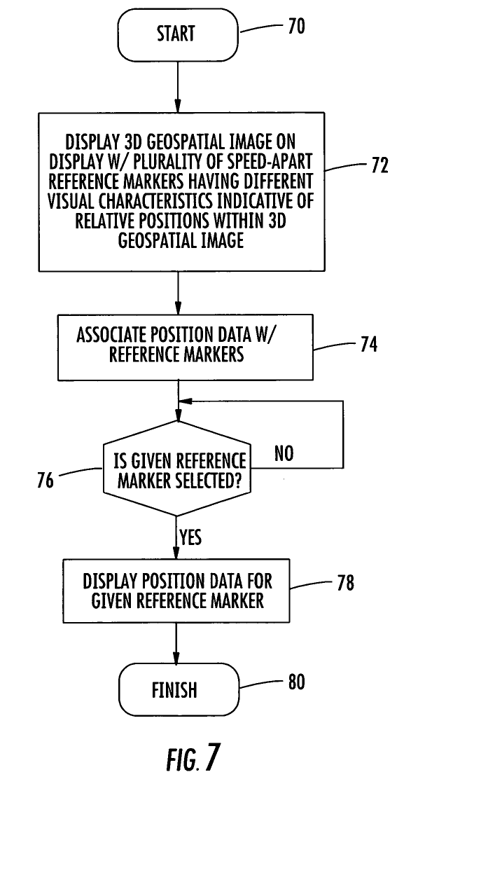

The reference markers may be semi-transparent geometric objects, such as semi-transparent spheres 30″, for example, as shown in FIG. 6. In particular, the spheres 30″ in the illustrated example delineate points on an object 40, which could be a building (i.e., a manmade structure), elevated terrain, etc. When a given reference marker intersects the object 40, the processor 23 may advantageously display only those portions of the given reference marker outside of the object, as shown, to further help the user appreciate the relative position and boundaries of the object while not obscuring the object itself.

The processor 23 may also cause the display 21 to selectively change the spacing between the reference markers 30a-30l based upon one of the input devices. For example, the processor 23 may change the spacing (i.e., density) of the reference markers 30a-30l based upon a scroll wheel of the mouse 24, which may be done in combination with pressing a particular key (e.g., CTRL key) on the keyboard 25. Thus, the user is able to quickly and conveniently change the spacing of the reference markers 30a-30l to suit the particular image or zoom level that the user is working with. Of course, the reference marker density may also be automatically updated as the user changes zoom-level, if desired.

The processor 23 may also selectively display the reference markers 30a-30l with the 3D geospatial image, i.e., only display them when requested by the user. For example, this may be done based upon one of the input devices such as the keyboard 25. More particularly, a specific key(s) on the keyboard 25 may be assigned for causing the processor 23 to display the reference markers 30a-30l when pressed or held down by the user (e.g., the space bar), and then “hide” the reference markers when the user releases the designated key(s). Of course, other methods may be used for instructing the processor 23 to display the reference markers 30a-30l (as well as performing the various functions described above), such as drop down menu items, buttons on a button bar, etc., as will be appreciated by those of skill in the art.

A three-dimensional (3D) geospatial image display method aspect will now be described with reference to FIG. 7. Beginning at Block 70, the method illustratively includes displaying a 3D geospatial image on the display 21 with a plurality of spaced-apart reference markers 30a-30l, at Block 72. As noted above, the reference markers 30a-30l preferably have different visual characteristics indicative of different relative positions within the 3D geospatial image (e.g., size, color, etc.).

The method may further include associating with each reference marker selectively displayable position data, at Block 74, as discussed further above. The processor 23 then cooperates with the mouse 24 and/or keyboard 25 to determine when a given reference marker 30 is selected, at Block 76. When this occurs, the processor 23 then performs the appropriate action, such as displaying the respective position data associated with the given reference marker 30, as noted above, at Block 78, thus concluding the illustrated method (Block 80).

The reference markers 30a-30l may be expanded to span an entire viewable scene (i.e., view frustum), or just portions thereof in different situations or implementations. Moreover, the reference markers 30a-30l may also advantageously be used to place pre-defined objects in the 3D scene, or to define entirely new objects by successively selecting markers, for example. Preferably the grid or matrix of reference markers 30a-30l will have a regular spacing by default. However, additional user or context-definable parameters may be used to automatically increase the sphere density in certain areas causing the dynamic increasing and decreasing of the grid density to be non-uniform or even non-linear throughout the extent of the grid, as will be appreciated by those skilled in the art.

Operational details of one exemplary embodiment of the computer system 20 will now be described to provide still further understanding. The keyboard 25 spacebar brings in (i.e. overlays) the matrix of reference markers 30a-30l (i.e., spheres), which are appropriately sized to match the context, over the whole image scene or some portion thereof. The keyboard 25 and/or joystick may be used to move the camera view around in the scene. Further, a scroll wheel on the mouse 24 dynamically increases/decreases the matrix density (i.e., inter-sphere spacing). Optionally, the dynamic grid density adjustment does not necessarily need to be uniform or linear across entire matrix/grid, as noted above.

Each time the mouse pointer 32 mouse moves over a selectable reference sphere, (a) if there is a ground surface portion below the sphere, a straight vertical reference line 35 is automatically drawn to the ground 31 to show exactly over what ground point that sphere lies, and (b) if the scene is within a GIS context (i.e. has an origin), the latitude/longitude/height coordinates of the given sphere are shown preferably even if no ground exists below. Optionally, the spheres may be colorized based upon height/elevation or distance from a certain point (showing appropriate color bar legend on the side of the scene). In addition, clicking on a given sphere may select it and optionally close out a polygon (or volprint, as discussed in U.S. Pat. No. 6,915,310 to Gutierrez et al., which is assigned to the present Assignee and is hereby incorporated herein by reference in its entirety) if more than one sphere is selected. In a degenerate polygon case, two selected spheres make a line, as will be appreciated by those skilled in the art.

The above-described computer system 20 and methods may provide several advantages. For example, they may provide full 3D context relatively fast and with few operations required by a user, as well as providing a GIS (latitude/longitude/height) context for any 3D point in a scene. Furthermore, radial colorization may be provided based upon a distance from a point or object, or planar colorization based upon a distance from surface (e.g. ground). Other advantages may include dynamic density calibration, as well as non-uniformity in dynamic density calibration (i.e., areas of interest can be adjusted to have a higher density than the rest of the matrix). Moreover, polygon orientation (i.e., winding, in computer graphic terms, which is used to determine if a polygon is front-facing or back-facing) may optionally be automatically deduced from the order that the user selects the spheres.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed:

1. A geographic information system (GIS) comprising:
a display;
a GIS database; and
a processor cooperating with said display and said GIS database to display a three-dimensional (3D) geospatial image including a plurality of spaced-apart reference markers therein, said reference markers having different visual characteristics indicative of different relative positions within the 3D geospatial image;
said processor also associating with each reference marker selectively displayable position data.

2. The GIS of claim 1 wherein the different visual characteristics comprise different sizes.

3. The GIS of claim 1 wherein the different visual characteristics comprise different colors.

4. The GIS of claim 1 further comprising an input device connected to said processor, and wherein said processor selectively displays position data for a given reference marker based upon said input device.

5. The GIS of claim 1 further comprising an input device cooperating with said processor to draw a line between a pair of reference markers; and wherein said processor cooperates with said display to display a distance between the pair of reference markers based upon the line.

6. The GIS of claim 1 further comprising an input device cooperating with said processor to select a given reference marker from among the plurality of reference markers; wherein the 3D geospatial image comprises a ground surface below the given reference marker; and wherein said processor cooperates with said display to draw a vertical reference line between the ground surface and the given reference marker upon selection thereof.

7. The GIS of claim 1 wherein the reference markers comprise semi-transparent geometric objects.

8. The GIS of claim 7 wherein the semi-transparent geometric objects comprise semi-transparent spheres.

9. The GIS of claim 1 wherein the selectively displayable position data comprises selectively displayable latitude, longitude, and height coordinates.

10. The GIS of claim 1 further comprising an input device connected to said processor, and wherein said processor cooperates with said display to selectively change the spacing between the reference markers based upon said input device.

11. The GIS of claim 1 wherein the spacing between at least some of the reference markers is non-uniform.

12. The GIS of claim 1 wherein the spacing between at least some of the reference markers is non-linear.

13. The GIS of claim 1 further comprising an input device connected to said processor, and wherein said processor selectively displays the plurality of reference markers with the 3D geospatial image based upon said input device.

14. The GIS of claim 1 further comprising an input device connected to said processor for selecting reference markers; wherein said 3D geospatial image comprises at least one polygon; and wherein said processor determines an orientation of said at least one polygon based upon an order of selection of reference markers associated therewith.

15. The GIS of claim 1 further comprising an input device connected to said processor for selecting reference markers; wherein said 3D geospatial image comprises at least one polygon; and wherein said processor determines an orientation of said at least one polygon based upon an order of selection of reference markers associated therewith.

16. A geographic information system (GIS) comprising:
a display;
a GIS database; and
a processor cooperating with said display and said GIS database to display a three-dimensional (3D) geospatial image including a plurality of spaced-apart reference markers therein, said reference markers having different sizes and different colors indicative of different relative positions within the 3D geospatial image;
said processor also associating with each reference marker selectively displayable position data.

17. The GIS of claim 12 further comprising an input device connected to said processor, and wherein said processor selectively displays position data for a given reference marker based upon said input device.

18. The GIS of claim 12 wherein the reference markers comprise semi-transparent geometric objects.

19. The GIS of claim 12 wherein the selectively displayable position data comprises selectively displayable latitude, longitude, and height coordinates.

20. A computer-readable medium having computer-executable instructions for performing steps comprising:
displaying a 3D geospatial image on a display with a plurality of spaced-apart reference markers therein, the reference markers having different visual characteristics indicative of different relative positions within the 3D geospatial image; and
associating with each reference marker selectively displayable position data.

21. The computer-readable medium of claim 16 wherein the different visual characteristics comprise at least one of different sizes and different colors.

22. The computer-readable medium of claim 16 further having computer-executable instructions for performing steps comprising:
drawing a line between a pair of reference markers; and
displaying a distance between the pair of reference markers based upon the line.

23. The computer-readable medium of claim 16 wherein the 3D geospatial image comprises a ground; and further having computer-executable instructions for performing steps comprising:
selecting a given reference marker from among the plurality of reference markers above the ground; and
drawing a vertical reference line between the ground and the given reference marker upon selection thereof.

24. The computer-readable medium of claim 16 wherein the reference markers comprise semi-transparent geometric objects.

25. A three-dimensional (3D) geospatial image display method comprising:
displaying the 3D geospatial image on a display with a plurality of spaced-apart reference markers therein, the reference markers having different visual characteristics indicative of different relative positions within the 3D geospatial image; and
associating with each reference marker selectively displayable position data.

26. The method of claim 25 wherein the different visual characteristics comprise at least one of different sizes and different colors.

27. The method of claim 25 further comprising:
drawing a line between a pair of reference markers; and
displaying a distance between the pair of reference markers based upon the line.

28. The method of claim 25 wherein the 3D geospatial image comprises a ground surface; and further comprising:
selecting a given reference marker from among the plurality of reference markers above the ground surface; and
drawing a vertical reference line between the ground and the given reference marker upon selection thereof.

29. The method of claim 25 wherein the reference markers comprise semi-transparent geometric objects.
